(19) United States
(12) Patent Application Publication
(10) Pub. No.: US 2010/0064786 A1
(43) Pub. Date: Mar. 18, 2010

(54) METHOD FOR ASCERTAINING THE SPEED OF A STARTER

(76) Inventors: Jie Ge, Stuttgart-Hausen (DE); Klaus Heyers, Reutlingen (DE); Apostolos Tsakiris, Ludwigsburg (DE)

Correspondence Address: KENYON & KENYON LLP, ONE BROADWAY, NEW YORK, NY, 10004, US

(21) Appl. No.: 12/310,308

(22) PCT Filed: Jul. 9, 2007
(86) PCT No.: PCT/EP2007/056980

§ 371 Date: Oct. 30, 2009

(30) Foreign Application Priority Data
Aug. 21, 2006 (DE) 10 2006 039 112.8

(51) Int. Cl. G01M 15/04

(52) U.S. Cl. 73/114.25

(57) ABSTRACT

A method for determining the speed of a starter for starting internal combustion engines. The starter speed may be ascertained in a particularly simple and cost-effective manner in that it is calculated from different electrical variables and is calibrated by comparison to the internal combustion engine speed.

### FIELD OF THE INVENTION

The present invention relates to a method for determining the speed of a starter for starting internal combustion engines.

### BACKGROUND INFORMATION

Internal combustion engines of today's motor vehicles are generally started by a so-called pinion starter. The latter comprises essentially a direct current motor having a motor-driven pinion, which is engaged into a ring gear of the crankshaft and cranks the internal combustion engine when a start is requested. If the engine control unit initiates a start command, this start command causes a so-called engagement relay pulls up and engages the pinion into the ring gear of the crankshaft. If the engagement relay is pulled up, a main current path is automatically closed, which supplies the starter with electrical power. This starts the actual cranking process.

In vehicles that are designed for start-stop operation, the pinion is in some cases engaged into the ring gear already before the internal combustion engine comes to a standstill. The subsequent starting process may thus be executed considerably faster since the pinion is already engaged when starting. In this case, as soon as a stop signal is detected, the starter is put into rotational speed and the pinion is engaged even before the internal combustion engine has completely come to a standstill. In order to ensure that the engagement is as low in noise and wear as possible, the starter pinion must be brought precisely to the circumferential speed of the crankshaft and be engaged synchronously. The speed of the starter must therefore be known very precisely.

The starter speed could be measured e.g. using a speed sensor. This is relatively complex and expensive, however.

### SUMMARY OF THE INVENTION

It is therefore an objective of the present invention to create a simple and cost-effective method for determining the speed of a starter.

This objective is achieved according to the present invention by the features indicated in Claim 1. Further developments of the present invention are the subject matter of dependent claims.

An essential aspect of the present invention is to calculate the starter speed from electrical variables. This has the advantage in particular that the speed may be determined without a special speed sensor and in a particularly simple and cost-effective manner.

According to an exemplary embodiment of the present invention, the starter speed n is calculated from the terminal voltage U₄₅ of the starter and/or the brush voltage U_{br} and possibly the armature current I of the starter. Appropriate current or voltage sensors may be provided for measuring the individual variables. The brush voltage may be estimated using an algorithm.

The starter speed may be calculated for example from the following relationship:

$$n = \frac{{U}_{45} - I \cdot {R}_{statt} - I \cdot {k}_{B} - {U}_{br}}{{k}_{n}} \qquad ( 1 )$$

In this instance,

U₄₅ is the outer terminal voltage of the starter
I is the starter current,
Rₛₜₐₜₜ is the armature resistance,
U_{br} is the brush voltage, and
kₙ is a machine parameter, that particularly takes into account the construction of the starter and the magnetic field intensity.
kB=constant for current-dependent brush voltage drop

The electrical variables U₄₅, U_{br} and I may be measured when idling, in particular when the starter is running down. In the currentless running down operation of the starter (i.e. the connection to the supply voltage is interrupted) equation (1) reduces to:

$$n = \frac{{U}_{45} - {U}_{br}}{{k}_{n}} \qquad ( 2 )$$

Voltages U₄₅ and U_{br} are generator variables.

At the beginning of the driving operation, in particular when cold starting, the starter speed may be calculated according to formula (1) or (2).

The calculation algorithm may be calibrated on the basis of a measured speed, in particular the engine speed. In the engaged state of the starter, the engine speed corresponds to the starter speed (taking into account the transmission ratio between the starter pinion and the ring gear or crankshaft). The engine speed is normally available in the engine control unit. The calculation algorithm (e.g. (1) or (2)) may thus be calibrated using the engine speed. For this purpose, a correction parameter (kₖₒᵣᵣ) may be determined for example.

In further starts, the starter heats up increasingly. Because of the dependency of variables U_{br} and kₙ on the starter temperature and the aging state of the starter, the starter speed calculated according to equation (1) or (2) may deviate relatively strongly from the actual value. The present invention therefore provides for the speed calculation to be adapted and at least for the temperature response to be compensated.

To calculate the starter speed n, the following equation may be applied for example:

$$n = \frac{{U}_{45} \cdot {k}_{korr} - {U}_{br} \cdot ( 1 - {k}_{br} \cdot Δ T )}{{k}_{n} ( 1 + {k}_{m} \cdot Δ T )} \qquad ( 3 )$$

In this case, ΔT is a temperature change of the starter as compared to the last start, kₘ and k_{br} are temperature coefficients, which may be linear and independent of temperature, and kₖₒᵣᵣ is a correction factor that corrects the deviation of the calculation in a cold start.

The initial temperature of the starter before the first start is assumed to be the same as the engine temperature. This is measured in all common engines and the value is available in the control unit.

The temperature change ΔT may result from a thermal model that reflects the thermal processes in the starter. To determine the starter temperature or the starter's temperature change, the energy loss occurring in a starting process may be estimated and the temperature or temperature change is calculated on the basis of the thermal model.

According a first specific embodiment of the present invention, the energy loss is determined on the basis of a data record stored in a memory. The data record includes for example the energy loss in a starting process as a function of an initial temperature in the form of a table (look-up table). The starter temperature or the starter's temperature change may then be calculated on the basis of the thermal model.

According to a second specific embodiment of the present invention, the energy loss W_{I} occurring in a starting process is ascertained from an electrical energy balance, for which

W_{I}=I²·Rₛₜₛₜ+U_{br}·I (4)

may be applied for example. In this instance, U_{br} is the brush voltage, I the armature current and Rₛₜₐₜ the ohmic resistance of the armature. In this instance, the brush voltage U_{br} is assumed as known, i.e. as a function of the current it is stored as a characteristics map or stored as a constant; and armature resistance Rₛₜₐₜ is known.

Armature current I from equation (4) may be ascertained, for example, from the speed characteristic of the starter in the starting process. For this purpose, the n=f(I) characteristic curve of the starter is stored as a characteristics map. This characteristic curve is then converted to the current temperature and provides the time-dependent starter currents. To determine the starter speed, the engine speed during the cranking phase provided by the engine control unit may be used.

Alternatively, armature current I could also be measured during the starting process and on this basis energy loss W_{I} could be ascertained. The starter temperature or the starter's temperature change is then in turn obtained from the thermal model for the starter.

The starter speed compensated with respect to the temperature, e.g. in accordance with equation (3), may in a subsequent start in turn be adapted to the measured actual value n. For this purpose, again in the engaged state of the starter, engine speed nₘₒₜ is measured, starter speed n is calculated e.g. in accordance with (3), and the calculation algorithm is corrected in the event of a deviation between the two speeds n, nₘₒₜ. For the purpose of the correction, a corrected temperature or a temperature change ΔT may be introduced for example. The temperature or temperature change ΔTₑₛₜ estimated by the thermal model may be corrected e.g. using a correction factor kₜₕ. The following relationship may be applied for example:

ΔT=kₜₕ·ΔTₑₛₜ (5)

where ΔTₑₛₜ is the temperature estimated by the thermal model.

In the following, the present invention is explained in greater detail by way of example with reference to the attached drawings.

### BRIEF DESCRIPTION OF THE FIGURES

FIG. 1 shows a schematic view of a pinion starter.

FIG. 2 shows a flow chart for showing the essential method steps of a method for calculating the starter speed n.

FIG. 3 shows a thermal model for the starter for determining a starter temperature or temperature change.

### DETAILED DESCRIPTION

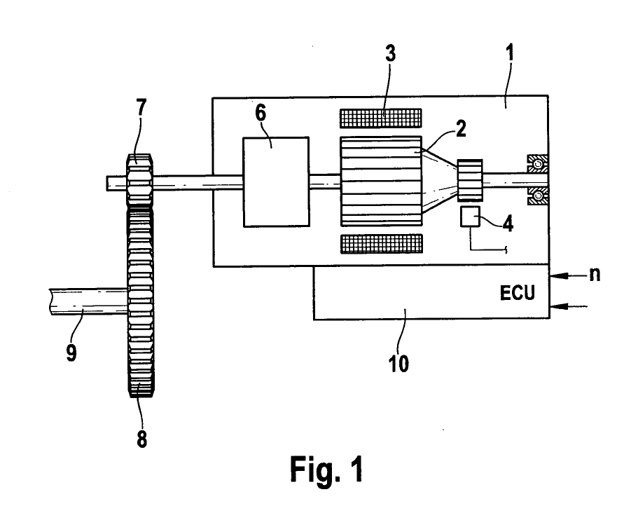

FIG. 1 shows a highly simplified schematic representation of a starter 1 for internal combustion engines as is used in particular in motor vehicles. Starter 1 includes essentially a direct current motor 2, 3, made up of an armature 2 having armature windings and a stator having several permanent magnets 3. The armature windings contained in armature 2 are supplied with electrical power via brushes 4. A pinion 7 is attached to motor shaft 5, which in a starting process engages into a ring gear 8 of crankshaft 9. An engaging mechanism 6 is provided for engaging and disengaging pinion 7, which usually includes an engaging lever and an engaging relay by which the main current path of starter 1 is switched.

Starter 1 includes its own starter control unit 10, which is used, among other things, to calculate the speed n of starter 1 and to control starter 1 accordingly. Starter 1 is in this case designed for use in vehicles that have a start-stop operation. In a start-stop operation, the internal combustion engine is automatically turned off in certain driving situations such as e.g. when stopping in front of a traffic light, and a stop signal STOP is generated in the process. As soon as the driver wants to drive off again and for this purpose releases the brake pedal for example, the internal combustion engine is restarted.

If the speed of the internal combustion engine has already dropped so far that a self-start is no longer possible, the internal combustion engine is started anew by starter 1. For this purpose, the pinion is first brought to the engine speed such that it runs synchronously with ring gear 8 and is then engaged into ring gear 8 of the decelerating engine. The starter speed n is calculated using a mathematical algorithm for which the following equation may be applied for example:

$$n = \frac{{U}_{45} \cdot {k}_{korr} - {U}_{br} \cdot ( 1 - {k}_{br} \cdot Δ T )}{{k}_{n} \cdot ( 1 + {k}_{m} \cdot Δ T )}$$

In this instance,

U₄₅ is the outer terminal voltage of the starter
I is the starter current,
Rₛₜₐₜ is the armature resistance,
U_{br} is the brush voltage, and
kₙ is a machine parameter, which particularly takes into account the construction of the starter and the magnetic field intensity, and
kₖₒᵣᵣ, K_{br}, and kₘ are correction factors.

In a cold start of internal combustion engine, ΔT=0 and kₖₒᵣᵣ=1. The ambient temperature such as e.g. the oil temperature is used as the starter temperature. The voltages U₄₅ (terminal voltage) and U_{br} (brush voltage) are measured when running up the starter in idle operation, and from this the speed n is calculated.

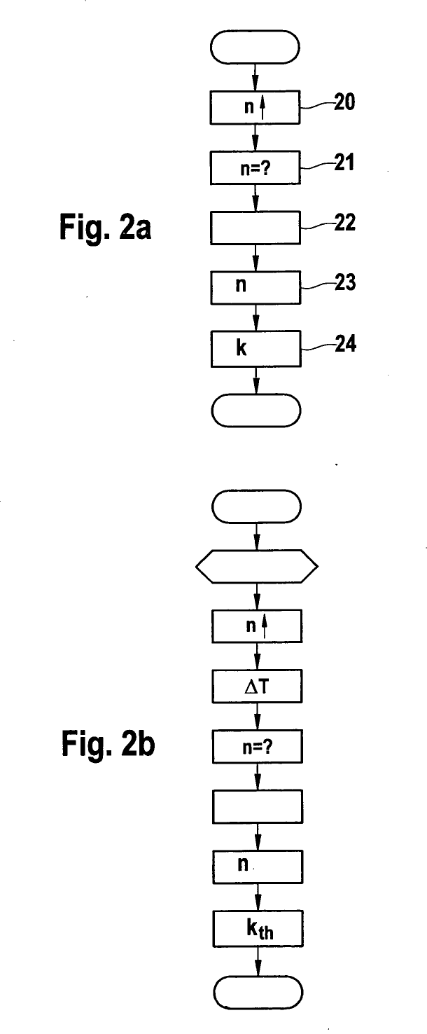

FIG. 2a shows the essential method steps of a method for calculating the starter speed n based on equation (3) in the case of a cold start. In step 20, starter 1 is first run up and pinion 7 is synchronized with ring gear 8. The speed n of starter 1 is calculated in step 21 on the basis of equation (3), where ΔT=0 and kₖₒᵣᵣ=1. Voltages U₄₅ and U_{br} are measured in idle operation. As soon as the desired speed n has been reached, pinion 7 is engaged into ring gear 8 of decelerating internal combustion engine (step 22).

If the engine speed in the engaged state corresponds to starter speed n (taking into account the transmission ratio), then the algorithm may be calibrated. For this purpose, the engine speed is measured in step 23 and in step 24 a correction factor kₖₒᵣᵣ is calculated, by which the algorithm (3) is adapted.

In subsequent starts, in which the starter temperature is higher than the ambient temperature, the temperature dependence of brush voltage U_{br} and of machine parameter kₙ, must be taken into account. For this purpose, the temperature or temperature change of the starter may be determined using a thermal model of the starter.

FIG. 2a shows the essential method steps of a method for calculating the starter speed n based on equation (3) in the case of a subsequent starting process (warm start). For this purpose, an ascertainment is made in a first step 30 whether a stop signal STOP exists. If yes (J), then starter 1 is run up and pinion 7 is synchronized with ring gear 8. The speed n of starter 1 is calculated in accordance with equation (3).

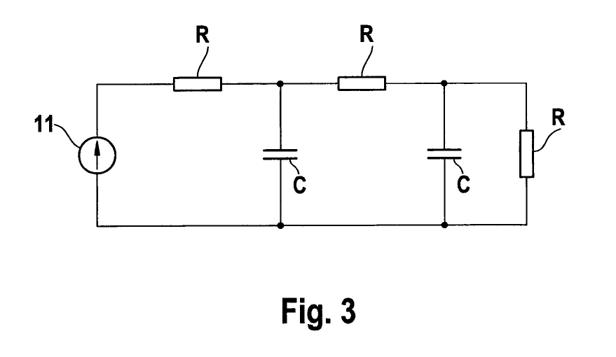

Temperature change ΔT from equation (3) is obtained from a temperature model of the starter as is shown in exemplary fashion in FIG. 3. In step 32, the temperature model calculates a temperature or temperature change of starter 1 by taking into account an initial temperature, the energy input in the last start and the cooling off time since the last start. The energy input may be calculated by equation (4) for example.

The result of the speed calculation is output in step 33. If starter speed n is equal to the engine speed, then pinion 7 is engaged in step 34.

In the following steps 35 and 36, the calculation algorithm is in turn calibrated. For this purpose, engine speed nₘₒₜ is measured in step 35 and compared to the previously calculated starter speed n. In the event of a deviation, a correction factor kₜₕ is ascertained in step 36 for the temperature estimated by the thermal model.

FIG. 3 shows the essential elements of a temperature model of starter 1, which in the present example includes a thermal resistor R_{zul} for the supply lines of starter 1, a thermal capacitor of armature C_{Ank}, a thermal resistor R_{Luftsp} of the air gap between brushes 4 and armature 2, a thermal capacitor of magnets 3 C_{Mag}, and a thermal leakage resistor R_{Abl} parallel to thermal capacitor C_{Mag} of magnets 3. The rate of heat flow flowing into the thermal network is indicated by reference numeral 11.

The rate of heat flow may be read out from a table stored in the system for example. Optionally, the rate of heat flow may be also be calculated from an energy balance, for which equation (4) may be applied for example.

Armature current I may be optionally measured or ascertained from the speed information of engine control unit nₘₒₜ. Brush voltage U_{br} may be estimated. As a result, the thermal model provides a temperature or temperature change, which is then inserted in equation (3).

1-13. (canceled)

14. A method for determining a speed of a starter, for a motor vehicle internal combustion engine, the method comprising:
calculating the speed using a calculation algorithm made up of electrical variables.

15. The method of claim 14, wherein the speed is calculated from at least one of a terminal voltage, a brush voltage, and an armature current.

16. The method of claim 14, wherein at least one of the electrical variables is measured in an idle operation of the starter.

17. The method of claim 14, wherein the calculation algorithm is calibrated, and the internal combustion engine speed is measured and compared to the calculated starter speed in an engaged state of the starter, and the calculation algorithm is corrected accordingly in the event of a deviation.

18. The method of claim 17, wherein at least one correction factor is ascertained for correcting the calculation algorithm.

19. The method of claim 14, wherein the calculation algorithm takes into account one of a starter temperature and a temperature change of the starter.

20. The method of claim 14, wherein an energy loss occurring in a starting process is determined and the temperature or temperature change of the starter is ascertained on the basis of a thermal model.

21. The method of claim 20, wherein the energy loss is determined on the basis of a data record stored in a memory, as a function of an initial temperature.

22. The method of claim 20, wherein the energy loss is ascertained on the basis of an electrical energy balance.

23. The method of claim 22, wherein a speed characteristic of the starter is measured during a starting process, and an armature current is ascertained on the basis of the speed characteristic, and the energy loss is calculated on this basis.

24. The method of claim 22, wherein the armature current of the starter is measured during a starting process and the energy loss is ascertained on this basis.

25. The method of claim 14, wherein the speed of the starter is calculated by:
$$n = \frac{{U}_{45} \cdot {k}_{korr} - {U}_{br} \cdot ( 1 - {k}_{br} \cdot Δ T )}{{k}_{n} \cdot ( 1 + {k}_{m} \cdot Δ T )}$$
where
U₄₅ is the outer terminal voltage of the starter (1) U_{br} is the brush voltage, and ΔT is the temperature change of the starter, and kₖₒᵣᵣ, k_{br} and kₘ are different correction factors.

26. The method of claim 14, wherein in an engaged state of the starter, the engine speed is measured and is compared to the calculated starter speed, and the temperature change is corrected in the event of a deviation.
